(19) United States
(12) Patent Application Publication
(10) Pub. No.: US 2024/0420115 A1
(43) Pub. Date: Dec. 19, 2024

(54) METHOD AND SYSTEM FOR IDENTIFYING TYPE OF ACCOUNT WHILE MAINTAINING ANONYMITY IN BLOCKCHAIN TRANSACTIONS

(71) Applicant: Mastercard International Incorporated, Purchase, NY (US)

(72) Inventors: Jaipal Singh KUMAWAT, Sikar (IN); Prathemesh Bhagwan BAGUL, Ratnagiri (IN); Ravi KANWAR, Bahadurgarh (IN)

(21) Appl. No.: 18/208,939

(22) Filed: Jun. 13, 2023

(51) Int. Cl. G06Q 20/36; G06Q 20/38

(52) U.S. Cl. CPC G06Q 20/3672; G06Q 20/3829; G06Q 20/389

(57) ABSTRACT

A method for account type registration for blockchain wallets includes: receiving, by a receiver of a processing server, a public key of a cryptographic key pair of a blockchain wallet associated with a blockchain; receiving, by the receiver of the processing server, an account identifier of a transaction account; identifying, by a processor of the processing server, an account type for the transaction account; and storing, in a data entry, at least the public key and an identifier associated with the identified account type.

### FIELD

The present disclosure relates to the tagging of blockchain accounts for instance as related to individuals or entities, specifically the identification of account types using associated transaction accounts for tagging of blockchain wallets.

### BACKGROUND

Blockchains were first developed as a way to process transactions and exchange cryptographic currency using a system that was both decentralized and anonymous. The decentralization of a blockchain network can provide for an exceedingly high difficulty in taking control of a blockchain or having fraudulent transactions successfully confirmed and added to a blockchain. Because a blockchain transfers currency between wallets without any identification regarding the owner of a wallet, blockchain transactions can traditionally be conducted between two anonymous parties. These benefits over traditional transactional systems that utilize fiat currencies have resulted in a measure of popularity for cryptographic currencies transacted using blockchains.

The anonymous nature of blockchain wallet ownership can enable individuals or entities to participate in transactions without having to provide identification. In some cases, an individual or entity can be subject to sanctions imposed by a regulatory agency, such as a government, payment processor, or other entity. The anonymity of a blockchain wallet can result in an individual or entity that is subject to such sanctions to be able to freely transact on a blockchain without recourse. Thus, there is a need for a technological solution to where an account type for a blockchain wallet can be identified for regulatory purposes without sacrificing anonymity.

### SUMMARY

The present disclosure provides a description of systems and methods for account type registration of blockchain wallets. When a blockchain wallet is registered, the owner provides a portion of a transaction account number for a transaction account issued to the owner. The portion of the transaction account number is used to identify an account type, such as ownership by an individual or an entity. The blockchain wallet is flagged for the identified account type in a data entry, which can be stored in a lookup table or a sidechain to the associated blockchain. The flag can then be used in future transactions, such as to ensure compliance with applicable regulations. In cases where an individual or entity can be subject to sanctions, such sanctions can be identified using the portion of the transaction account number, where associated flags can be stored along with the account type flag, for use in ensuring compliance with such sanctions in future blockchain transactions. As a result, an individual or entity can be kept in compliance without having to provide identification, keeping the anonymity provided by a blockchain.

A method for account type registration for blockchain wallets includes: receiving, by a receiver of a processing server, a public key of a cryptographic key pair of a blockchain wallet associated with a blockchain; receiving, by the receiver of the processing server, an account identifier of a transaction account; identifying, by a processor of the processing server, an account type for the transaction account; and storing, in a data entry, at least the public key and an identifier associated with the identified account type.

A system for account type registration for blockchain wallets includes: a blockchain; and a processing server, the processing server including a receiver receiving a public key of a cryptographic key pair of a blockchain wallet associated with a blockchain, and an account identifier of a transaction account, and a processor identifying an account type for the transaction account, and storing, in a data entry, at least the public key and an identifier associated with the identified account type.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high-level system architecture for account type registration for blockchain wallets in accordance with exemplary embodiments.

FIG. 2 is a block diagram illustrating the processing server in the system of FIG. 1 for account type registration for blockchain wallets in accordance with exemplary embodiments.

FIGS. 3A and 3B are a flow diagram illustrating a process for account type registration of a blockchain wallet in the system of FIG. 1 in accordance with exemplary embodiments.

FIG. 4 is a flow diagram illustrating a process for determining a blockchain transaction is subject to one or more sanctions in the system 100 in accordance with exemplary embodiments.

FIG. 5 is a flow chart illustrating an exemplary method for account type registration for blockchain wallets in accordance with exemplary embodiments.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments is intended for illustration purposes only and are, therefore, not intended to necessarily limit the scope of the disclosure.

### DETAILED DESCRIPTION

### System for Registration of Account Type for Blockchain Wallets

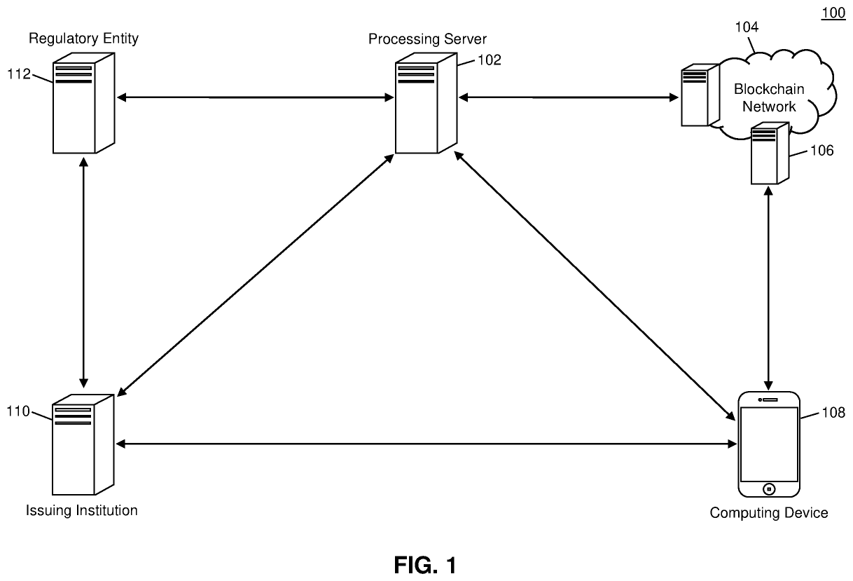

FIG. 1 illustrates a system 100 for the registration of an account type for a blockchain wallet, which can be flagged accordingly for regulatory purposes and for compliance with applicable sanctions. The system 100 can include a processing server 102. The processing server 102, discussed in more detail below, can be configured to register account types of blockchain wallets and identify and manage flags for account types and imposed sanctions.

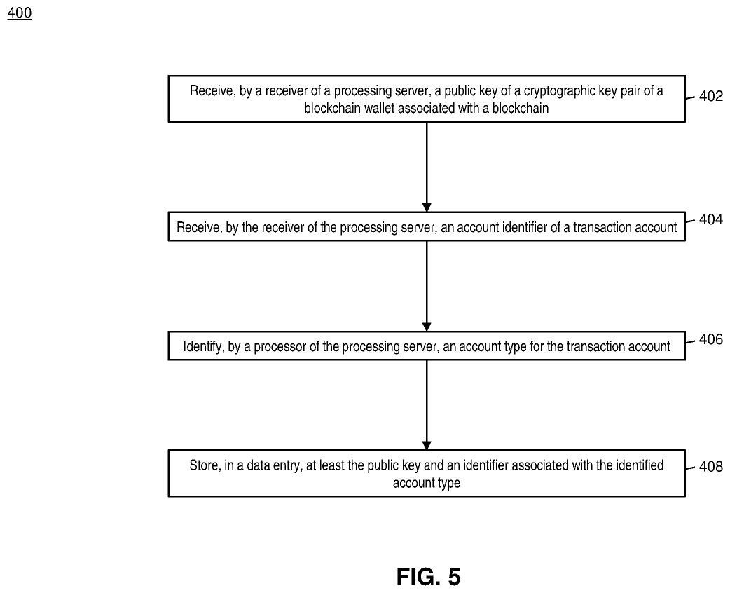

The system 100 can also include a blockchain network 104. The blockchain network 104 can be comprised of a plurality of blockchain nodes 106. Each blockchain node 106 can be a computing system, such as illustrated in FIG. 5, discussed in more detail below, that is configured to perform functions related to the processing and management of the blockchain, including the generation of blockchain data values, verification of proposed blockchain transactions, verification of digital signatures, generation of new blocks, validation of new blocks, and maintenance of a copy of the blockchain. In some embodiments, the processing server 102 can be a blockchain node 106.

The blockchain can be a distributed ledger that is comprised of at least a plurality of blocks. Each block can include at least a block header and one or more data values. Each block header can include at least a timestamp, a block reference value, and a data reference value. The timestamp can be a time at which the block header was generated and can be represented using any suitable method (e.g., UNIX timestamp, DateTime, etc.). The block reference value can be a value that references an earlier block (e.g., based on timestamp) in the blockchain. In some embodiments, a block reference value in a block header can be a reference to the block header of the most recently added block prior to the respective block. In an exemplary embodiment, the block reference value can be a hash value generated via the hashing of the block header of the most recently added block. The data reference value can similarly be a reference to the one or more data values stored in the block that includes the block header. In an exemplary embodiment, the data reference value can be a hash value generated via the hashing of the one or more data values. For instance, the block reference value can be the root of a Merkle tree generated using the one or more data values.

The use of the block reference value and data reference value in each block header can result in the blockchain being immutable. Any attempted modification to a data value would require the generation of a new data reference value for that block, which would thereby require the subsequent block's block reference value to be newly generated, further requiring the generation of a new block reference value in every subsequent block. This would have to be performed and updated in every single blockchain node 106 in the blockchain network 104 prior to the generation and addition of a new block to the blockchain in order for the change to be made permanent. Computational and communication limitations can make such a modification exceedingly difficult, if not impossible, thus rendering the blockchain immutable.

In some embodiments, the blockchain can be used to store information regarding blockchain transactions conducted between two different blockchain wallets. A blockchain wallet can include a private key of a cryptographic key pair that is used to generate digital signatures that serve as authorization by a payer for a blockchain transaction, where the digital signature can be verified by the blockchain network 104 using the public key of the cryptographic key pair. In some cases, the term “blockchain wallet” can refer specifically to the private key. In other cases, the term “blockchain wallet” can refer to a computing device (e.g., computing device 108, etc.) that stores the private key for use thereof in blockchain transactions. For instance, each computing device can each have their own private key for respective cryptographic key pairs and can each be a blockchain wallet for use in transactions with the blockchain associated with the blockchain network. Computing devices can be any type of device suitable to store and utilize a blockchain wallet, such as a desktop computer, laptop computer, notebook computer, tablet computer, cellular phone, smart phone, smart watch, smart television, wearable computing device, implantable computing device, etc.

Each blockchain data value stored in the blockchain can correspond to a blockchain transaction or other storage of data, as applicable. A blockchain transaction can consist of at least: a digital signature of the sender of currency (e.g., a computing device 108) that is generated using the sender's private key, a blockchain address of the recipient of currency (e.g., another computing device 108) generated using the recipient's public key, and a blockchain currency amount that is transferred, or other data being stored. In some blockchain transactions, the transaction can also include one or more blockchain addresses of the sender where blockchain currency is currently stored (e.g., where the digital signature proves their access to such currency), as well as an address generated using the sender's public key for any change that is to be retained by the sender. Addresses to which cryptographic currency has been sent that can be used in future transactions are referred to as “output” addresses, as each address was previously used to capture output of a prior blockchain transaction, also referred to as “unspent transactions,” due to there being currency sent to the address in a prior transaction where that currency is still unspent. In some cases, a blockchain transaction can also include the sender's public key, for use by an entity in validating the transaction. For the traditional processing of a blockchain transaction, such data can be provided to a blockchain node 106 in the blockchain network 104, either by the sender or the recipient. The node can verify the digital signature using the public key in the cryptographic key pair of the sender's wallet and also verify the sender's access to the funds (e.g., that the unspent transactions have not yet been spent and were sent to address associated with the sender's wallet), a process known as “confirmation” of a transaction, and then include the blockchain transaction in a new block. The new block can be validated by other blockchain nodes 106 in the blockchain network 104 before being added to the blockchain and distributed to all of the blockchain nodes 106 in the blockchain network 104, respectively, in traditional blockchain implementations. In cases where a blockchain data value cannot be related to a blockchain transaction, but instead the storage of other types of data, blockchain data values can still include or otherwise involve the validation of a digital signature.

In the system 100, a computing device 108 can create a new blockchain wallet for use with the blockchain associated with the blockchain network 104. The blockchain wallet can be used by the computing device 108 to receive or transfer cryptographic currency or other value that is transferred or otherwise has ownership maintained via the blockchain. In the system 100, the user of the computing device 108 that owns and/or operates the wallet, or any transactions involving the user, such as those conducted using the new blockchain wallet, can be subject to one or more regulations established by one or more regulatory entities 112. A regulatory entity 112 can be any entity that establishes regulations on the transfer or use of currency, including cryptographic currency, participation in blockchain transactions, or other regulations that can affect a user that participates in the blockchain associated with the blockchain network 104. Examples of regulatory entities 112 can include, for instance, a government, a financial institution, a law enforcement agency, a standards organization, etc. In an exemplary embodiment, a regulatory entity 112 can impose one or more regulations that can be applicable to blockchain transactions depending on if a participant of the transaction is an individual or an entity.

In order to identify an account type for a user of a new blockchain account, the processing server 102 can utilize a transaction account issued to the user. In the system 100, the user of the computing device 108 can have previously been issued a transaction account by an issuing institution 110. The issuing institution 110 can be any entity that issues transaction accounts to users for use in sending or receiving currency, including fiat currencies, such as credit card accounts, debit accounts, etc. The issuing institution 110 can be a financial institution, such as an issuing bank, or other suitable entity. As part of the creation of a transaction account, the user can provide proof of identity to the issuing institution 110, which enables the issuing institution 110 to identify if the user is an individual or an entity, and, in some cases, a more specific type of individual or entity. The issuing institution 110 can issue a transaction account to the computing device 108 and, as part of the issuing of the transaction account, generate and issue a transaction account number, also referred to as a payment account number, that is uniquely associated with the transaction account.

When the computing device 108 creates a new blockchain account, the computing device 108 can register the new blockchain account with the processing server 102. For registration, the computing device 108 can provide an identifier associated with the new blockchain account as well as at least a portion of the transaction account number. The identifier can be the public key or other value that is unique to the new blockchain account and can be used for the identification thereof. The portion of the transaction account number can comprise the first four numbers of the transaction account number or other portion that can be utilized by the processing server 102 for identification of an account type for the computing device 108, as discussed below. The computing device 108 can provide the registration data to the processing server 102 using any suitable communication network and method. For example, the computing device 108 can submit the data to the processing server 102 via a web page or via an application program that directly transmits the data to the processing server 102, such as via the Internet.

The processing server 102 can receive the registration data and can use the portion of the transaction account number to identify an account type for the new blockchain account, where the account type can be individual or entity, indicating if the user that operates, owns, or is otherwise associated with the new blockchain account is an individual or an entity. For example, an individual account type indicates that the blockchain account is the owner's personal blockchain account whereas an entity account type indicates that the blockchain account is operated by one or more users on behalf of an entity such as a business, a corporation, an organization, a government, etc. In some embodiments, the processing server 102 can electronically transmit the portion of the transaction account number to the issuing institution 110 using any suitable communication network and method, where the issuing institution 110 can identify an account type for the associated transaction account and provide the account type back to the processing server 102. In other embodiments, the portion of the transaction account number can indicate the account type for the computing device 108. For example, when the transaction account is issued for the user of the computing device 108 the issuing institution 110 can identify the account type for the user and provide the transaction account number such that the account type is reflected in the transaction account number. For example, one or more digits, letters, and/or symbols in the transaction account number can be reflective of the account type of the user, such as a “4” in the fifth position indicating an individual and a “5” in the fifth position indicating an entity. In such embodiments, the processing server 102 can identify the account type for the user of the new blockchain wallet by identifying the value of the appropriate position in the portion of the transaction account number. As another example, a certain pattern of alphanumeric characters and/or symbols within the transaction account number can indicate the account type. In such embodiments, the processing server 102 can identify the account type for the user of the new blockchain wallet by identifying the pattern of alphanumeric characters and/or symbols in the portion of the transaction account number. In other embodiments, the computing device 108 can submit an indication of account type to the processing server 102 with the registration data. In such embodiments, the processing server can electronically transmit the indication of account type along with the portion of the transaction account number to the issuing institution 110 using any suitable communication network and method, where the issuing institution 110 can confirm and/or correct the account type for the associated transaction account and provide the conformation and/or correct account type back to the processing server 102.

Once the account type for the new blockchain wallet is identified, the processing server 102 can flag the new blockchain wallet accordingly. The flag can indicate the account type for the new blockchain wallet. The flag can be stored in a location such that the flag can be accessed as needed, such as when a new blockchain transaction is attempted that involves the new blockchain wallet as a participant. In some embodiments, the processing server 102 can store the flag in a data entry that also includes the public key of the new blockchain wallet in a lookup table, such as can be stored in a memory or database of the processing server 102 that is accessible by any suitable system. In other embodiments, a sidechain, which can be separate to the blockchain but associated therewith, operated by the blockchain network 104 or a separate blockchain network 104 can be used. In such embodiments, the public key and account type flag can be stored in a new blockchain data entry that is added to the sidechain using traditional systems and methods. In embodiments where a lookup table is used, the flag stored in the data entry in the lookup table can be updated if the account type for the new blockchain wallet changes. In latter embodiments, a new blockchain data entry can be added to the sidechain that includes an updated flag and the public key when the account type for the new blockchain wallet changes, where the latest blockchain data entry that includes the public key can be used to identify the current account type for the new blockchain wallet.

When a blockchain node 106 in the blockchain network 104 receives a new blockchain transaction that includes the new blockchain wallet as a participant, the blockchain node 106 can identify the account type flag for the new blockchain wallet in the sidechain or lookup table. The blockchain node 106 can then ensure compliance of the new blockchain transaction with any applicable regulations based on the account type. For example, if individuals are limited to a maximum transaction amount for transactions, the blockchain node 106 can ensure that the transaction amount for the new blockchain transaction is within the maximum amount during the confirmation process for the new blockchain transaction if the account type flag for the new blockchain wallet indicates that the user is an individual. As a result, compliance with applicable regulations based on account type can be ensured without having to directly identify the user of the new blockchain wallet or obtain the full transaction account number.

In some embodiments, flags can be used to ensure compliance with any sanctions that are imposed on participants in the blockchain associated with the blockchain network 104. In such embodiments, the processing server 102 can identify when sanctions are imposed on a blockchain wallet. In some cases, a regulatory entity 112 or other entity that imposes sanctions can electronically transmit data regarding the sanctions and an identifier for the blockchain wallet to the processing server 102 when sanctions are applied, or when the status of a sanction changes. In other cases, the processing server 102 can request sanction data for a blockchain wallet from the regulatory entity 112 or other entity that imposes sanctions, such as by providing the public key for the blockchain wallet and receiving the sanction data as a response. In some instances, the portion of the transaction account number can be used for identification of the user of the blockchain wallet for use in identifying any sanctions that are to be applied to the blockchain wallet or transactions involving the blockchain wallet.

Once sanction data is received, the processing server 102 can identify and/or generate one or more sanction flags for ensuring compliance with the sanction(s) and store the one or more sanction flags in the data entry for the blockchain wallet in the lookup table or sidechain. The sanction flags can then be used in future blockchain transactions that involve the blockchain wallet as a participant. For example, the blockchain node 106 can identify all of the sanction flags in the latest data entry for the blockchain wallet of the computing device 108 and ensure compliance with the identified sanction flags in a new blockchain transaction that involves the blockchain wallet of the computing device 108. In some cases, sanctions can limit transaction amounts, transaction participants, transaction frequencies, times and/or dates of transactions, etc., or can require reporting of transaction activity, where the blockchain node 106 or processing server 102 can ensure such reporting for compliance with the applicable sanctions based on the sanction flags.

In some embodiments, if a blockchain wallet participates in a blockchain transaction with another blockchain wallet that has one or more sanction flags, the blockchain wallet can then be flagged as a result of the relationship with the blockchain wallet with the one or more sanction flags. For example, if an unsanctioned blockchain wallet receives cryptographic currency from a sanctioned blockchain wallet, the unsanctioned blockchain wallet can be flagged for transaction reporting, such as to monitor for participation of the unsanctioned blockchain wallet in potentially unauthorized behavior.

In some embodiments, a hashed transaction account number can be used for identification using the methods discussed above. For example, the computing device 108 can hash the transaction account number for the transaction account issued to the user thereof by the issuing institution 110, e.g., instead of transmitting a portion of the transaction account number to the processing server 102. The resulting hash value can be transmitted to the processing server 102 for use in identifying the account type and any applicable sanctions for identifying the appropriate flags to store in the data entry with the public key of the blockchain wallet of the computing device 108. In an exemplary embodiment, a one-way hashing algorithm such as Message Digest 5 (MD5) and Secure Hashing Algorithm (SHA) 1 and 2 to name two, can be used such that the transaction account number cannot be obtained from the hash value. In such cases, the processing server 102 can use the hashed transaction account number without ever obtaining or using the actual transaction account number and thus maintaining anonymity of the user of the computing device 108. The issuing institution 110 and regulatory entity 112 can hash the transaction account number themselves using the same one-way hashing algorithm. As a result, the processing server 102 can request account type data or sanction data using the hashed transaction account number, where the issuing institution 110 and regulatory entity 112 can identify the account type or sanction data, as applicable, using the hash value.

The methods and systems discussed herein provide for the registration of an account type for a blockchain wallet. By identifying the account type and storing an appropriate flag in a sidechain or lookup table, any applicable regulations can be complied with for future blockchain transactions or other activity by a blockchain wallet. By using only a portion of a transaction account number, the account type flag can be identified and established without having to identify the user of the new blockchain wallet, which can result in the positive compliance without sacrificing the anonymity traditionally provided by a blockchain. As a result, additional functionality can be introduced into a blockchain without sacrificing the existing benefits of blockchains.

### Processing Server

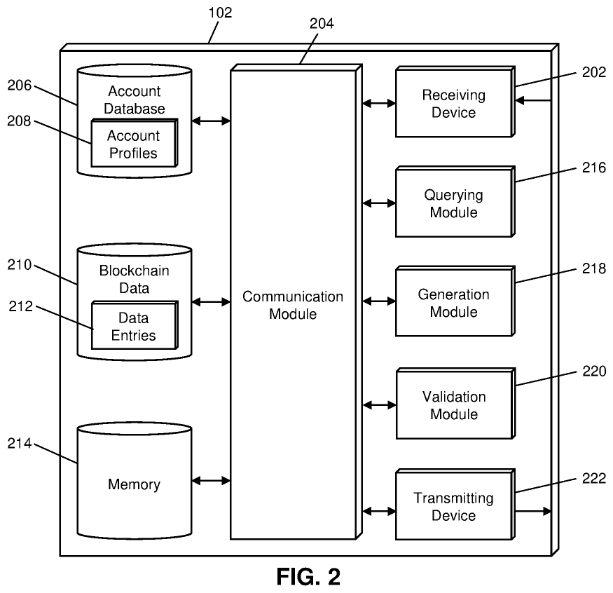

FIG. 2 illustrates an embodiment of the processing server 102 in the system 100 of FIG. 1. It will be apparent to persons having skill in the relevant art that the embodiment of the processing server 102 illustrated in FIG. 2 is provided as illustration only and is not exhaustive of all possible configurations of the processing server 102 suitable for performing the functions as discussed herein. For example, the computer system 500 illustrated in FIG. 5 and discussed in more detail below can be a suitable configuration of the processing server 102. In some cases, other components of the system 100, such as the blockchain nodes 106, computing device 108, issuing institution 110, and regulatory entity 112 can include the components illustrated in FIG. 2 and discussed below.

The processing server 102 can include a receiving device 202. The receiving device 202 can be configured to receive data over one or more networks via one or more network protocols. In some instances, the receiving device 202 can be configured to receive data from blockchain nodes 106, computing devices 108, issuing institutions 110, regulatory entities 112, and other systems and entities via one or more communication methods, such as radio frequency, local area networks, wireless area networks, cellular communication networks, Bluetooth, the Internet, etc. In some embodiments, the receiving device 202 can be comprised of multiple devices, such as different receiving devices for receiving data over different networks, such as a first receiving device for receiving data over a local area network and a second receiving device for receiving data via the Internet. The receiving device 202 can receive electronically transmitted data signals, where data can be superimposed or otherwise encoded on the data signal and decoded, parsed, read, or otherwise obtained via receipt of the data signal by the receiving device 202. In some instances, the receiving device 202 can include a parsing module for parsing the received data signal to obtain the data superimposed thereon. For example, the receiving device 202 can include a parser program configured to receive and transform the received data signal into usable input for the functions performed by the processing device to carry out the methods and systems described herein.

The receiving device 202 can be configured to receive data signals electronically transmitted by blockchain nodes 106 that are superimposed or otherwise encoded with blockchain data entries, blockchain transactions, public keys, requests for account flags, etc. The receiving device 202 can also be configured to receive data signals electronically transmitted by computing devices 108, which can be superimposed or otherwise encoded with registration data for new blockchain wallets, public keys, portions of transaction account numbers, hashed transaction account numbers, new blockchain transactions, etc. The receiving device 202 can also be configured to receive data signals electronically transmitted by issuing institutions 110 and/or regulatory entities 112 that can be superimposed or otherwise encoded with account type data, sanction data, sanction updates, etc.

The processing server 102 can also include a communication module 204. The communication module 204 can be configured to transmit data between modules, engines, databases, memories, and other components of the processing server 102 for use in performing the functions discussed herein. The communication module 204 can be comprised of one or more communication types and utilize various communication methods for communications within a computing device. For example, the communication module 204 can be comprised of a bus, contact pin connectors, wires, etc. In some embodiments, the communication module 204 can also be configured to communicate between internal components of the processing server 102 and external components of the processing server 102, such as externally connected databases, display devices, input devices, etc. The processing server 102 can also include a processing device. The processing device can be configured to perform the functions of the processing server 102 discussed herein as will be apparent to persons having skill in the relevant art. In some embodiments, the processing device can include and/or be comprised of a plurality of engines and/or modules specially configured to perform one or more functions of the processing device, such as a querying module 216, generation module 218, validation module 220, etc. As used herein, the term “module” can be software or hardware particularly programmed to receive an input, perform one or more processes using the input, and provides an output. The input, output, and processes performed by various modules will be apparent to one skilled in the art based upon the present disclosure.

The processing server 102 can also include an account database 206. The account database 206 can be configured to store one or more account profiles 208 using a suitable data storage format and schema. The account database 206 can be a relational database that utilizes structured query language for the storage, identification, modifying, updating, accessing, etc. of structured data sets stored therein. Each account profile 208 can be a structured data set configured to store data related to a blockchain wallet. An account profile 208 can include, for example, a public key of the cryptographic key pair of the related blockchain wallet, an account type flag, and one or more sanction flags, if applicable, a portion of a transaction account number, a hashed transaction account number, etc. In some embodiments, the account database 206 can be a lookup table that can be accessed by the processing server 102 and one or more systems external to the processing server 102, such as blockchain nodes 106, regulatory entities 112, etc. In some embodiments, the account database 206 can be a sidechain, that can be accessed by the processing server 102 and one or more systems external to the processing server 102, such as blockchain nodes 106, regulatory entities 112, etc.

The processing server 102 can also include blockchain data 210. The blockchain data 210 an include any data entries 212 associated with the blockchain network 104, e.g., a copy of the blockchain associated with the blockchain network 104, and/or data associated with the sidechain, e.g., the account database 206 as described above.

The processing server 102 can also include a memory 214. The memory 214 can be configured to store data for use by the processing server 102 in performing the functions discussed herein, such as public and private keys, symmetric keys, etc. The memory 214 can be configured to store data using suitable data formatting methods and schema and can be any suitable type of memory, such as read-only memory, random access memory, etc. The memory 214 can include, for example, encryption keys and algorithms, communication protocols and standards, data formatting standards and protocols, program code for modules and application programs of the processing device, and other data that can be suitable for use by the processing server 102 in the performance of the functions disclosed herein as will be apparent to persons having skill in the relevant art. In some embodiments, the memory 214 can be comprised of or can otherwise include a relational database that utilizes structured query language for the storage, identification, modifying, updating, accessing, etc. of structured data sets stored therein. The memory 214 can be configured to store, for example, cryptographic keys, cryptographic key pairs, cryptographic algorithms, encryption algorithms, communication information, data formatting rules, network identifiers, transaction histories, blockchain wallet data, account flag data, sanction data, etc.

The processing server 102 can include a querying module 216. The querying module 216 can be configured to execute queries on databases to identify information. The querying module 216 can receive one or more data values or query strings and can execute a query string based thereon on an indicated database, such as the account database 206 of the processing server 102 to identify information stored therein. The querying module 216 can then output the identified information to an appropriate engine or module of the processing server 102 as necessary. The querying module 216 can, for example, execute a query on the account database 206 to identify an account profile 208 associated a blockchain wallet for a new blockchain transaction to identify flags stored therein for applicability to the new blockchain transaction.

The processing server 102 can also include a generation module 218. The generation module 218 can be configured to generate data for use by the processing server 102 in performing the functions discussed herein. The generation module 218 can receive instructions as input, can generate data based on the instructions, and can output the generated data to one or more modules of the processing server 102. For example, the generation module 218 can be configured to generate data messages, notification messages, data entries, blockchain data entries, sanction messages, transaction reports, etc. For example, the processing server 102 may generate a transaction notification message to the regulatory entity 112 and/or the issuing institution 110 for a received blockchain transaction where one or more of the transaction accounts of the blockchain transaction are subject to one or more sanctions.

The processing server 102 can also include a validation module 220. The validation module 220 can be configured to perform validations for the processing server 102 as part of the functions discussed herein. The validation module 220 can receive instructions as input, which can also include data to be used in performing a validation, can perform a validation as requested, and can output a result of the validation to another module or engine of the processing server 102. The validation module 220 can, for example, be configured to validate compliance with applicable sanctions as a result of account type and/or sanction flags. The processing server 102 may approve or deny a blockchain transaction based on the result of the validation. For example, if a blockchain transaction includes a transaction account subject to one or more sanctions and the blockchain transaction is not in compliance with the one or more sanctions, the processing server 102 may deny the blockchain transaction or otherwise prevent the blockchain transaction from being submitted to the blockchain network 104 for confirmation.

The processing server 102 can also include a transmitting device 222. The transmitting device 222 can be configured to transmit data over one or more networks via one or more network protocols. In some instances, the transmitting device 222 can be configured to transmit data to blockchain nodes 106, computing devices 108, issuing institutions 110, regulatory entities 112, and other entities via one or more communication methods, local area networks, wireless area networks, cellular communication, Bluetooth, radio frequency, the Internet, etc. In some embodiments, the transmitting device 222 can be comprised of multiple devices, such as different transmitting devices for transmitting data over different networks, such as a first transmitting device for transmitting data over a local area network and a second transmitting device for transmitting data via the Internet. The transmitting device 222 can electronically transmit data signals that have data superimposed that can be parsed by a receiving computing device. In some instances, the transmitting device 222 can include one or more modules for superimposing, encoding, or otherwise formatting data into data signals suitable for transmission.

The transmitting device 222 can be configured to electronically transmit data signals to blockchain nodes 106 that are superimposed or otherwise encoded with blockchain data, blockchain data entries, account flags, sanction data, new blockchain transactions, etc. The transmitting device 222 can also be configured to electronically transmit data signals to computing devices 108, which can be superimposed or otherwise encoded with data requests, sanction data, notification messages, hashing data, etc. The transmitting device 222 can also be configured to electronically transmit data signals to issuing institutions 110 and/or regulatory entities 112 that can be superimposed or otherwise encoded with account type requests, sanction data requests, portions of transaction account numbers, hashed transaction account numbers, reporting data, etc.

### Process for Account Type Registration of a Blockchain Wallet

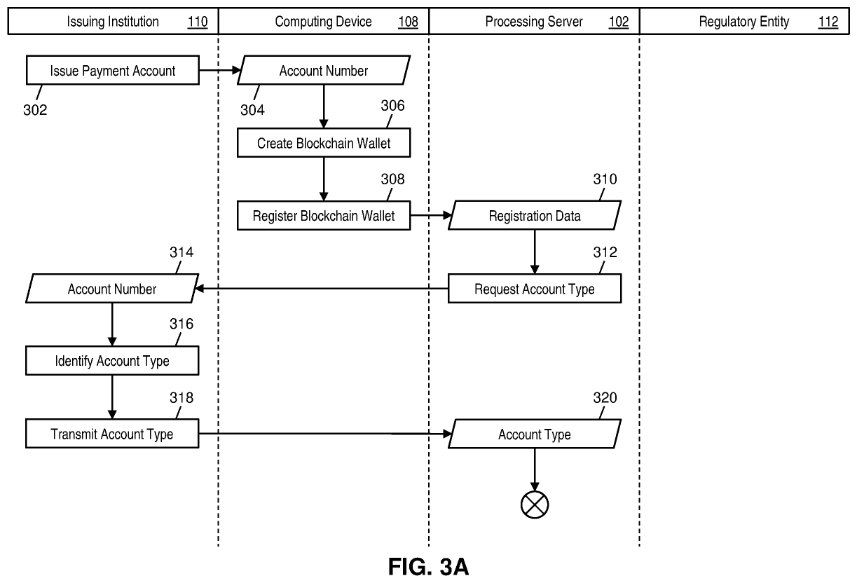

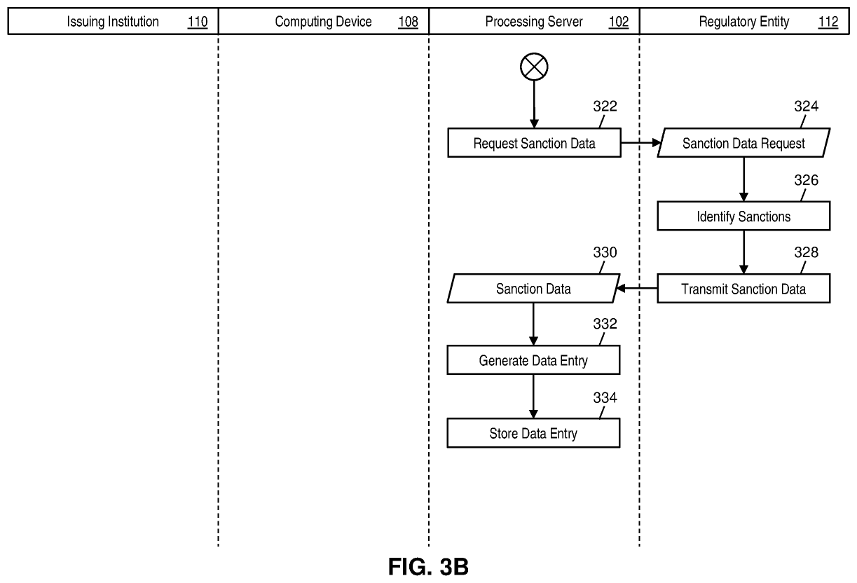

FIGS. 3A and 3B illustrate a process for registering an account type and sanction data for a new blockchain wallet in the system 100 of FIG. 1.

In step 302, the issuing institution 110 can issue a transaction account to a user of the computing device 108. As part of the issuing of a transaction account, the issuing institution 110 can generate a transaction account number for the transaction account, which can be provided to the computing device 108 using a suitable communication network and method. In step 304, the computing device 108 can receive the transaction account number for the transaction account. In step 306, the computing device 108 can generate a new blockchain wallet. Generation of the new blockchain wallet can include the generation of a new cryptographic key pair that includes a public key and private key. In step 308, the computing device 108 can register the new blockchain wallet with the processing server 102. As part of the registration, the computing device 108 can hash the transaction account number and electronically transmit at least the public key and hashed transaction account number to the processing server 102 using a suitable communication network and method. In some embodiments, instead of a hashed transaction account number, the computing device 108 may transmit a portion of the transaction account number, e.g., a portion of the transaction account number sufficient to identify an account type. In step 310, the receiving device 202 of the processing server 102 can receive the public key and hashed transaction account number and/or the portion of the transaction account number from the processing server 102.

In step 312, the transmitting device 222 of the processing server 102 can electronically transmit an account type request to the issuing institution 110 using a suitable communication network and method. The account type request can include at least the hashed transaction account number and/or the portion of the transaction account number. In step 314, the issuing institution 110 can receive the hashed transaction account number and/or the portion of the transaction account number from the processing server 102. In step 316, the issuing institution 110 can identify a transaction account that matches the hashed transaction account number and/or the portion of the transaction account number and then identify the account type for the transaction account as individual or entity. In step 318, the issuing institution 110 can electronically transmit the account type to the processing server 102 using a suitable communication network and method. In step 320, the receiving device 202 of the processing server 102 can receive the account type from the issuing institution 110.

In step 322, the transmitting device 222 of the processing server 102 can electronically transmit a request for sanction data to a regulatory entity 112. The request for sanction data can include the hashed transaction account number and/or the portion of the transaction account number. In step 324, the regulatory entity 112 can receive the sanction data request from the processing server 102. In step 326, the regulatory entity 112 can identify the transaction account that matches the hashed transaction account number and/or the portion of the transaction account number and identify any sanctions that have been imposed on the user of the transaction account. In step 328, the regulatory entity 112 can electronically transmit data regarding the identified sanctions to the processing server 102 using a suitable communication network and method.

In step 330, the receiving device 202 of the processing server 102 can receive the sanction data from the regulatory entity 112. In step 332, the generation module 218 of the processing server 102 can generate a new data entry for the new blockchain wallet that includes at least the public key of the new blockchain wallet, an account type flag based on the account type data received from the issuing institution 110, and one or more sanction flags based on the sanction data received from the regulatory entity 112. In some cases, the new data entry can further include the hashed transaction account number and/or the portion of the transaction account number. In step 334, the processing server 102 can store the data entry. In some embodiments, the data entry can be an account profile 208 stored in the account database 206 as a lookup table that can be used by blockchain nodes 106 and/or regulatory entities 112 for ensuring compliance in future blockchain transactions involving the new blockchain wallet. In other embodiments, the data entry can be a blockchain data entry stored in a sidechain to the blockchain, which can be added to the sidechain by the processing server 102 or a blockchain node 106 using traditional systems and methods. The account type flag and sanction flags can then be used for compliance in future blockchain transactions.

### Process for Account Type Registration of a Blockchain Wallet

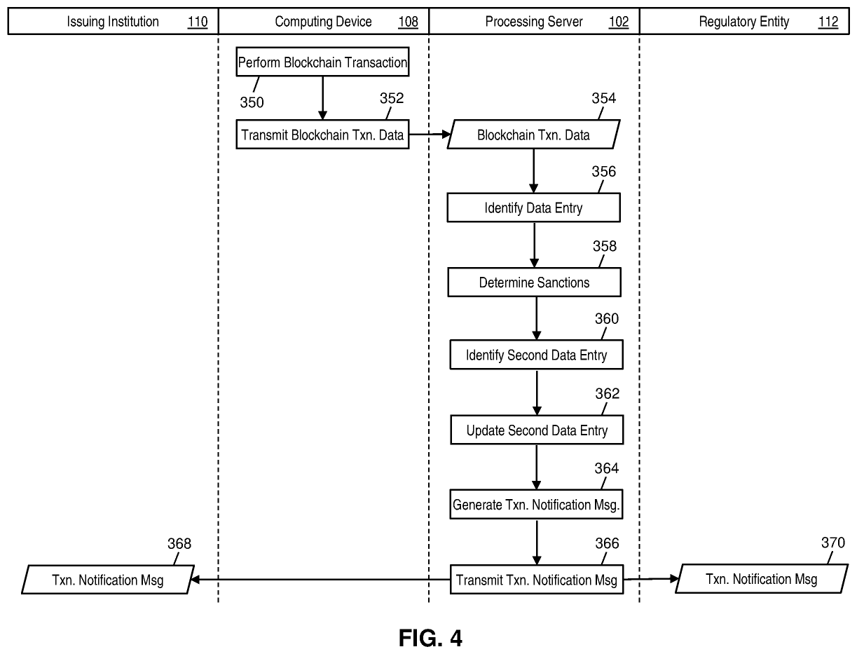

FIG. 4 illustrates a process for determining a blockchain transaction is subject to one or more sanctions in the system 100 of FIG. 1.

In step 350, the computing device 108 can conduct a blockchain transaction with one or more second parties. In step 352, the computing device 108 can transmit transaction data for the blockchain transaction to the processing server 102. The transaction data can include at least a public key of the computing device 108, a second public key associated with a second party of the blockchain transaction.

In step 354, the receiving device 202 of the processing server 102, can receive the transaction data for the blockchain transaction. In step 356, the processing server 102 identifies a data entry (e.g., an account profile 208) associated with the public key of the computing device 108 and determines if the transaction account of the computing device 108 is subject to one or more sanctions based on the data entry (e.g., the account profile 208) in step 358. If the processing server 102 determines the transaction account of the computing device 108 is subject to one or more sanctions, in step 360, the processing server 102 can identify a second data entry (e.g., a second account profile 208) associated with the second public key associated with the second party of the blockchain transaction.

In step 362, the processing server 102 can update the second data entry (e.g., a second account profile 208) associated with the second public key associated with the second party of the blockchain transaction based on the one or more sanctions from the data entry associated with the transaction account of the computing device 108. For example, the processing server 102 may create an entry in the second data entry identifying the transaction account, public key, or other suitable identification of the transaction account of the computing device 108. In another embodiment, the processing server 102 may generate a flag in the second data entry, the flag identifying the second data entry as being associated with the data entry associated with the computing device 108, e.g., the party subject to one or more sanctions. In this way, the account database 206 can identify known associates or any party transacting with a transaction account subject to one or more sanctions.

In step 364, the processing server 102 can generate a transaction notification message. The transaction notification message notifying one or more third-parties (e.g., the issuing institution 110 and/or the regulatory entity 112) of the blockchain transaction and the transaction account subject to the one or more sanctions. In step 366, the processing server 102 transmits the transaction notification message to the issuing institution 110 and/or the regulatory entity 112, which receive the transaction notification message at step 368 and 370, respectively.

### Exemplary Method for Account Type Registration of Blockchain Wallets

FIG. 5 illustrates a method 400 for the registration of the account type of a user of a new blockchain wallet via the use of an associated transaction account.

In step 402, a public key can be received by a receiver (e.g., receiving device 202) of a processing server (e.g., processing server 102), where the public key is of a cryptographic key pair of a blockchain wallet associated with a blockchain. In step 404, an account identifier of a transaction account can be received by the receiver of the processing server. In step 406, an account type for the transaction account can be identified by a processor (e.g., querying module 216) of the processing server. In step 408, at least the public key and an identifier associated with the identified account type can be stored in a data entry (e.g., account profile 208).

In one embodiment, the data entry can be a blockchain data value, and the blockchain data value can be stored in a second blockchain separate from the blockchain. In some embodiments, the method 400 can further include identifying, by the processor of the processing server, one or more sanctions imposed on the transaction account, wherein the data entry can further include one or more identifiers associated with the one or more sanctions. In a further embodiment, the method 400 can also include: receiving, by the receiver of the processing server, transaction data for a new blockchain transaction, the transaction data including at least the public key and a second public key; identifying, by the processor of the processing server, a second data entry that includes the second public key; and storing, by the processor of the processing server, at least one of the one or more identifiers in the second data entry.

In an even further embodiment, the new blockchain transaction can be subject to one or more sanctions. If the new blockchain transaction is determined to be subject to one or more sanctions, the processor of the processing server may deny the new blockchain transaction or otherwise prevent to new blockchain transaction from being submitted to the blockchain network 104 for confirmation. Further, if the new blockchain transaction is determined to be subject to one or more sanctions, the processor of the processing server may generate a transaction notification message based on the data for the new blockchain transaction and transmits (e.g., via the transmitting device 222) the transaction notification message to the regulatory entity 112 and/or the issuing institution 110.

In one embodiment, the method 400 can also include generating, by the processor of the processing server, a hash value by hashing the account identifier using a one-way hashing algorithm, wherein the data entry can further include the generated hash value. In some embodiments, the account identifier can be a portion of a payment account number. In one embodiment, the account type can be one of an individual or an entity.

### Computer System Architecture

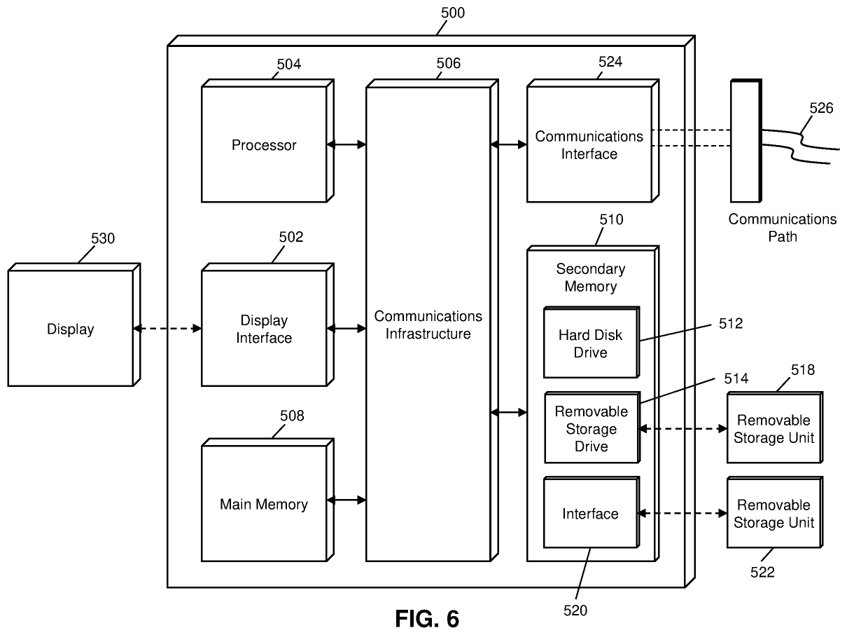

FIG. 6 illustrates a computer system 500 in which embodiments of the present disclosure, or portions thereof, can be implemented as computer-readable code. For example, the processing server 102, blockchain nodes 106, computing device 108, issuing institution 110, regulatory entity 112 can be implemented in the computer system 500 using hardware, non-transitory computer readable media having instructions stored thereon, or a combination thereof and can be implemented in one or more computer systems or other processing systems. Hardware can embody modules and components used to implement the methods of FIGS. 3A, 3B, 4, and 5.

If programmable logic is used, such logic can execute on a commercially available processing platform configured by executable software code to become a specific purpose computer or a special purpose device (e.g., programmable logic array, application-specific integrated circuit, etc.). A person having ordinary skill in the art can appreciate that embodiments of the disclosed subject matter can be practiced with various computer system configurations, including multi-core multiprocessor systems, minicomputers, mainframe computers, computers linked or clustered with distributed functions, as well as pervasive or miniature computers that can be embedded into virtually any device. For instance, at least one processor device and a memory can be used to implement the above-described embodiments.

A processor unit or device as discussed herein can be a single processor, a plurality of processors, or combinations thereof. Processor devices can have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations can be described as a sequential process, some of the operations can in fact be performed in parallel, concurrently, and/or in a distributed environment, and with program code stored locally or remotely for access by single or multi-processor machines. In addition, in some embodiments the order of operations can be rearranged without departing from the spirit of the disclosed subject matter.

Processor device 504 can be a special purpose or a general-purpose processor device specifically configured to perform the functions discussed herein. The processor device 504 can be connected to a communications infrastructure 506, such as a bus, message queue, network, multi-core message-passing scheme, etc. The network can be any network suitable for performing the functions as disclosed herein and can include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 can also include a main memory 508 (e.g., random access memory, read-only memory, etc.), and can also include a secondary memory 510. The secondary memory 510 can include the hard disk drive 512 and a removable storage drive 514, such as a floppy disk drive, a magnetic tape drive, an optical disk drive, a flash memory, etc.

The removable storage drive 514 can read from and/or write to the removable storage unit 518 in a well-known manner. The removable storage unit 518 can include a removable storage media that can be read by and written to by the removable storage drive 514. For example, if the removable storage drive 514 is a floppy disk drive or universal serial bus port, the removable storage unit 518 can be a floppy disk or portable flash drive, respectively. In one embodiment, the removable storage unit 518 can be non-transitory computer readable recording media.

In some embodiments, the secondary memory 510 can include alternative means for allowing computer programs or other instructions to be loaded into the computer system 500, for example, the removable storage unit 522 and an interface 520. Examples of such means can include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) can be stored on any type of suitable computer readable media, such as optical storage (e.g., a compact disc, digital versatile disc, Blu-ray disc, etc.) or magnetic tape storage (e.g., a hard disk drive). The data can be configured in any type of suitable database configuration, such as a relational database, a structured query language (SQL) database, a distributed database, an object database, etc. Suitable configurations and storage types will be apparent to persons having skill in the relevant art.

The computer system 500 can also include a communications interface 524. The communications interface 524 can be configured to allow software and data to be transferred between the computer system 500 and external devices. Exemplary communications interfaces 524 can include a modem, a network interface (e.g., an Ethernet card), a communications port, a PCMCIA slot and card, etc. Software and data transferred via the communications interface 524 can be in the form of signals, which can be electronic, electromagnetic, optical, or other signals as will be apparent to persons having skill in the relevant art. The signals can travel via a communications path 526, which can be configured to carry the signals and can be implemented using wire, cable, fiber optics, a phone line, a cellular phone link, a radio frequency link, etc.

The computer system 500 can further include a display interface 502. The display interface 502 can be configured to allow data to be transferred between the computer system 500 and external display 530. Exemplary display interfaces 502 can include high-definition multimedia interface (HDMI), digital visual interface (DVI), video graphics array (VGA), etc. The display 530 can be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium can refer to memories, such as the main memory 508 and secondary memory 510, which can be memory semiconductors (e.g., DRAMs, etc.). These computer program products can be means for providing software to the computer system 500. Computer programs (e.g., computer control logic) can be stored in the main memory 508 and/or the secondary memory 510. Computer programs can also be received via the communications interface 524. Such computer programs, when executed, can enable computer system 500 to implement the present methods as discussed herein. In particular, the computer programs, when executed, can enable processor device 504 to implement the methods illustrated by FIGS. 3A, 3B, 4, and 5, as discussed herein. Accordingly, such computer programs can represent controllers of the computer system 500. Where the present disclosure is implemented using software, the software can be stored in a computer program product and loaded into the computer system 500 using the removable storage drive 514, interface 520, and hard disk drive 512, or communications interface 524.

The processor device 504 can comprise one or more modules or engines configured to perform the functions of the computer system 500. Each of the modules or engines can be implemented using hardware and, in some instances, can also utilize software, such as corresponding to program code and/or programs stored in the main memory 508 or secondary memory 510. In such instances, program code can be compiled by the processor device 504 (e.g., by a compiling module or engine) prior to execution by the hardware of the computer system 500. For example, the program code can be source code written in a programming language that is translated into a lower-level language, such as assembly language or machine code, for execution by the processor device 504 and/or any additional hardware components of the computer system 500. The process of compiling can include the use of lexical analysis, preprocessing, parsing, semantic analysis, syntax-directed translation, code generation, code optimization, and any other techniques that can be suitable for translation of program code into a lower-level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for account type registration for blockchain wallets. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or can be acquired from practicing of the disclosure, without departing from the breadth or scope.

What is claimed is:

1. A method for account type registration for blockchain wallets, comprising:
receiving, by a receiving device of a processing server, a public key of a cryptographic key pair of a blockchain wallet associated with a blockchain;
receiving, by the receiving device of the processing server, an account identifier of a transaction account;
identifying, by the processing server, an account type for the transaction account; and
storing, in a data entry, at least the public key and an identifier associated with the identified account type.

2. The method of claim 1, wherein
the data entry is a blockchain data value, and
the blockchain data value is stored in a second blockchain separate from the blockchain.

3. The method of claim 1, further comprising:
identifying, by the processing server, one or more sanctions imposed on the transaction account, wherein
the data entry further includes one or more identifiers associated with the one or more sanctions.

4. The method of claim 3, further comprising:
receiving, by the receiving device of the processing server, transaction data for a new blockchain transaction, the transaction data including at least the public key and a second public key;
identifying, by the processing server, a second data entry that includes the second public key; and
storing, by the processing server, at least one of the one or more identifiers in the second data entry.

5. The method of claim 4, wherein the new blockchain transaction is subject to the one or more sanctions.

6. The method of claim 4, the method further comprising:
updating, by the processing server, the second data entry based on the one or more sanctions imposed on the transaction account

7. The method of claim 4, the method further comprising:
generating, by the processing server, a transaction notification message based on the data for the new blockchain transaction; and
transmitting, by a transmitting device of the processing server, the transaction notification message to a regulatory entity.

8. The method of claim 1, further comprising:
generating, by the processing server, a hash value by hashing the account identifier using a one-way hashing algorithm, wherein
the data entry further includes the generated hash value.

9. The method of claim 1, wherein the account identifier is a portion of a payment account number.

10. The method of claim 1, wherein the account type is one of an individual or an entity.

11. A system for account type registration for blockchain wallets, comprising:
a blockchain; and
a processing server, the processing server configured to:
receive a public key of a cryptographic key pair of a blockchain wallet associated with a blockchain,
receive an account identifier of a transaction account,
a processor
identify an account type for the transaction account, and
store, in a data entry, at least the public key and an identifier associated with the identified account type.

12. The system of claim 11, wherein
the data entry is a blockchain data value, and
the blockchain data value is stored in a second blockchain separate from the blockchain.

13. The system of claim 11, wherein
the processing server is configured to identify one or more sanctions imposed on the transaction account, and
the data entry further includes one or more identifiers associated with the one or more sanctions.

14. The system of claim 13, wherein the processing server is configured to:
receive transaction data for a new blockchain transaction, the transaction data including at least the public key and a second public key,
identify a second data entry that includes the second public key, and
store at least one of the one or more identifiers in the second data entry.

15. The system of claim 14, wherein the new blockchain transaction is subject to the one or more sanctions.

16. The method of claim 14, wherein the new blockchain transaction is subject to the one or more sanctions, and
the processing server is configured to deny the new blockchain transaction.

17. The method of claim 14, wherein the new blockchain transaction is subject to the one or more sanctions,
the processing server is configured to generate a transaction notification message based on the data for the new blockchain transaction, and
a transmitting device of the processing server is configured to transmit the transaction notification message to a regulatory entity.

18. The system of claim 11, wherein
the processing server is configured to generate a hash value by hashing the account identifier using a one-way hashing algorithm, and
the data entry further includes the generated hash value.

19. The system of claim 11, wherein the account identifier is a portion of a payment account number.

20. The system of claim 11, wherein the account type is one of an individual or an entity.
